(19) United States
(12) Patent Application Publication
(10) Pub. No.: US 2024/0141235 A1
(43) Pub. Date: May 2, 2024

(54) HYDROGEN PRODUCTION SYSTEM AND HYDROGEN PRODUCTION METHOD USING BIOCHAR OVEN

(71) Applicant: Kookmin University Industry Academy Cooperation Foundation, Seoul (KR)

(72) Inventor: Dong Hoon SHIN, Seoul (KR)

(73) Assignee: Kookmin University Industry Academy Cooperation Foundation, Seoul (KR)

(21) Appl. No.: 18/495,385

(22) Filed: Oct. 26, 2023

(30) Foreign Application Priority Data
Oct. 27, 2022 (KR) 10-2022-0139975
Oct. 23, 2023 (KR) 10-2023-0141904

(51) Int. Cl. C10B 3/02; B01D 53/02; C01B 3/24; C01B 3/56; C10B 47/18; C10B 53/02; C10B 53/04; C10B 53/07; C10B 57/16

(52) U.S. Cl. CPC C10B 3/02; B01D 53/02; C01B 3/24; C01B 3/56; C10B 47/18; C10B 53/02; C10B 53/04; C10B 53/07; C10B 57/16; B01D 2253/102; B01D 2256/16; B01D 2257/502; B01D 2257/504; C01B 2203/0266; C01B 2203/0425; C01B 2203/0838; C01B 2203/1614

(57) ABSTRACT

Disclosed is a hydrogen production system using a biochar oven, the system including: a vertical pyrolysis furnace into which a pyrolysis target including at least one of waste plastic and fossil fuel is supplied in a free fall scheme by its own weight; a plate-shaped flameless heater configured to heat the vertical pyrolysis furnace such that a high-temperature atmosphere of 800 to 1300° C. is generated therein; a solid-gas separator installed under a bottom of the vertical pyrolysis furnace and configured to receive a biochar-gas mixture produced from the vertical pyrolysis furnace and to separate the biochar-gas mixture into the BOG and the biochar and to discharge the BOG and the biochar; and a BOG purification unit configured to receive therein the biochar separated using the solid-gas separator therefrom, and use the received biochar as an adsorbent, wherein the BOG separated using the solid-gas separator passes through the received biochar in the BOG purification unit such that impurities contained in the BOG are removed therefrom.

### TECHNICAL FIELD

The present disclosure relates to a hydrogen production system using a biochar oven and a hydrogen production method using the biochar oven. More specifically, the present disclosure relates to a hydrogen production system using a biochar oven and a hydrogen production method using the biochar oven in which a plate-shaped flameless heater heats a vertical pyrolysis furnace such that an inner space of the vertical pyrolysis furnace is converted to a high temperature atmosphere of 700° C. to 1100° C., and, thus, biochar and BOG (Biochar Oven Gas) are produced during pyrolysis treatment on a pyrolysis target, and then, the produced BOG is used as fuel for the plate-shaped flameless heater.

### BACKGROUND ART

Recently, humanity's awareness of infectious diseases such as Corona has changed and thus the use of disposable plastics has been rapidly increasing. Due to the absence of effective treatment methods of the disposable plastics, marine pollution due to unauthorized dumping thereof is rapidly increasing.

In general, industrial waste plastics and household waste plastics are recycled or disposed of depending on whether they can be recycled. Among the waste plastics that cannot be recycled, non-corrosive waste plastics are incinerated or melted and solidified depending on whether they can be burned, and then may be used as construction materials. However, thereafter, they cannot be recycled anymore, and thus are disposed of via incineration.

In a method of producing hydrogen via incineration and combustion, a lot of dusts and harmful gases (CO, CO₂, HCN, NO₂, NH₃, NOₓ, CH₃, CH₃Cl, CCl₂F₂, CCl₄, CH₃CCl₃, CHBr₃, CH₃Br) including dioxin are released in burning fossil fuels. A lot of dusts and harmful gases are major causes of environmental pollution. In particular, the dioxin has a fatal effect on human, animal and plant life.

Since most waste plastics are petrochemical products with very low natural decomposition ability, an economical and safe treatment scheme thereof is needed.

In Korea, there are 2 million tons of unused forest biomass annually, and 70 million tons of biomass resources including wastes are generated. Thus, technology to utilize the biomass and the waste to separate carbon and produce hydrogen is required.

A scheme for producing hydrogen using the waste and the biomass mainly uses a gasification reaction in which an oxidizing agent as a gasifier is introduced. Since the gasification reaction is an endothermic reaction, heat supply via combustion is essential.

Biomass gasification occurs at a temperature between 700° C. and 1200° C., and the gasifier includes air, oxygen, and water vapor. However, in order to achieve a high hydrogen concentration, the water vapor is usually used as the gasifier. Generally, the biomass gasification process produces hydrogen gas using a dual circulating fluidized bed gasifier composed of a bubbling fluidized bed and a circulating fluidized bed.

This is known to have good reaction efficiency as it transfers heat using a sand fluidized bed and gasifies the biomass via bubbling, but has the disadvantage that a large amount of particles is present in the produced gas. Further, the fluidized medium may not be separated from the residual carbon. Furthermore, as self-combustion heat is used to supply the heat required for pyrolysis, a certain amount of oxidizer is added and thus the heating value of the produced gas is reduced accordingly. Thus, efficiency and economic feasibility are lowered. The complex process is an obstacle to large-scale and commercialization.

In addition to the fluidized bed, a fixed bed type and a molten bed type are used. However, there is a problem with frequent facility failure due to tar and slag generated during thermochemical reaction. Thus, it is difficult to enlarge the size of the facility.

### PRIOR ART LITERATURE

### Patent Literature

(Patent Document 0001) Korean Patent Application Publication No. 10-2021-0095332

### DISCLOSURE

### Technical Purpose

A purpose of the present disclosure is to provide a hydrogen production system using a biochar oven and a hydrogen production method using the biochar oven in which a plate-shaped flameless heater heats a vertical pyrolysis furnace such that an inner space of the vertical pyrolysis furnace is converted to a high temperature atmosphere of 700° C. to 1100° C., and, thus, biochar and BOG are produced during pyrolysis treatment on a pyrolysis target, and then, the produced BOG is used as fuel for the plate-shaped flameless heater.

Another purpose of the present disclosure is to provide a hydrogen production system using a biochar oven and a hydrogen production method using the biochar oven in which biochar adsorbs and separates carbon from waste plastic and fossil fuels such as coal, oil, LPG, and natural gas to produce hydrogen therefrom.

### Technical Solution

One aspect of the present disclosure provides a hydrogen production system using a biochar oven, the system comprising: a vertical pyrolysis furnace configured to perform pyrolysis treatment of a pyrolysis target including at least one of waste plastic and fossil fuel under a high temperature atmosphere of 700° C. to 1100° C.; and a plate-shaped flameless heater configured to heat the vertical pyrolysis furnace, and to use biochar oven gas (BOG) produced from the vertical pyrolysis furnace as fuel to heat the vertical pyrolysis furnace.

Another aspect of the present disclosure provides a hydrogen production system using a biochar oven, the system comprising: a vertical pyrolysis furnace into which a pyrolysis target including at least one of waste plastic and fossil fuel is supplied in a free fall scheme by its own weight; a plate-shaped flameless heater configured to heat the vertical pyrolysis furnace such that a high-temperature atmosphere of 800 to 1300° C. is generated therein; a solid-gas separator installed under a bottom of the vertical pyrolysis furnace and configured to receive a biochar-gas mixture produced from the vertical pyrolysis furnace and to separate the biochar-gas mixture into the BOG and the biochar and to discharge the BOG and the biochar; and a BOG purification unit configured to receive therein the biochar separated using the solid-gas separator therefrom, and use the received biochar as an adsorbent, wherein the BOG separated using the solid-gas separator passes through the received biochar in the BOG purification unit such that impurities contained in the BOG are removed therefrom.

In one implementation of the hydrogen production system, the vertical pyrolysis furnace vertically extends through the plate-shaped flameless heater and is heated by the heater.

In one implementation of the hydrogen production system, a flameless burner is installed on a top of the plate-shaped flameless heater and is located on one side of the vertical pyrolysis furnace.

In one implementation of the hydrogen production system, the BOG purified using the BOG purification unit is used as fuel of the plate-shaped flameless heater.

In one implementation of the hydrogen production system, contaminated biochar used for the BOG purification in the BOG purification unit is reintroduced into the vertical pyrolysis furnace and is subjected to a pyrolysis process therein.

In one implementation of the hydrogen production system, a temperature control device is installed at the BOG purification unit and is configured to control a temperature of the BOG purification unit in an electrical or mechanical scheme.

In one implementation of the hydrogen production system, the pyrolysis target is one of waste plastic, a mixture of waste plastic and biomass, a waste mask including PP and PE as a filter material, or a fossil fuel including LPG, petroleum, coal, and liquefied natural gas.

In one implementation of the hydrogen production system, the biomass includes one of wood pellets, wood chips, livestock manure pellets, coffee grounds, or tofu residues, or a mixture thereof.

Still another aspect of the present disclosure provides a hydrogen production method using a biochar oven, the method comprising: inputting a pyrolysis target into a vertical pyrolysis furnace in a free fall manner under a gravity; generating heat in a range of 800 to 1300° C. from a plate-shaped flameless heater installed on one side of the vertical pyrolysis furnace to maintain an internal temperature of the vertical pyrolysis furnace at around 700 to 1100° C. such that a biochar-gas mixture is produced from the vertical pyrolysis furnace; transferring a biochar-gas mixture produced from the vertical pyrolysis furnace is to a solid-gas separator in which the solid-gas separator separates the biochar-gas mixture into solid biochar and gaseous BOG, and discharges the solid biochar downwardly by gravity, and discharges the gaseous BOG upwardly to an exhaust pipe; filling the solid biochar separated using the solid-gas separator into a BOG purification unit so as to be used as an adsorbent thereby; and passing the BOG separated using the solid-gas separator through the biochar contained in the BOG purification unit such that the adsorbent absorbs and removes impurities contained in the BOG.

In one implementation of the hydrogen production method, the pyrolysis target is mixed with biomass or biochar and a mixture thereof is put into the pyrolysis furnace.

In one implementation of the hydrogen production method, the BOG purified using the BOG purification unit is used as fuel of the plate-shaped flameless heater.

In one implementation of the hydrogen production method, contaminated biochar used for the BOG purification in the BOG purification unit is reintroduced into the vertical pyrolysis furnace and is subjected to a pyrolysis process therein.

In one implementation of the hydrogen production method, a temperature control device is installed at the BOG purification unit and is configured to control a temperature of the BOG purification unit in an electrical or mechanical scheme.

In one implementation of the hydrogen production method, the pyrolysis target is one of waste plastic, a mixture of waste plastic and biomass, a waste mask including PP and PE as a filter material, or a fossil fuel including LPG, petroleum, coal, and liquefied natural gas.

### Technical Effect

According to the present disclosure, the biochar and the BOG may be produced in the pyrolysis treatment of the pyrolysis target in which the vertical pyrolysis furnace is heated to have a high temperature atmosphere of 700° C. to 1100° C. therein using the plate-shaped flameless heater. The produced BOG may be used as the fuel for the plate-shaped flameless heater. Thus, the pyrolysis target may be safely treated, and, at the same time, economical by-products may be obtained in a simple process.

Furthermore, the hydrogen production system and the method of the present disclosure may separate 30 to 50% of the carbons contained in the pyrolysis target therefrom, and may store the separated carbons into storage. Thus, blue hydrogen may be produced using the pyrolysis target. A concentration of hydrogen contained in the produced BOG is around 50% and a concentration of CO contained therein is around 40%, such that the produced BOG may be used as an alternative fuel to natural gas. Furthermore, the produced BOG may be used as a gas raw material for various chemical processes.

Furthermore, according to the present disclosure, the produced biochar may be used to restore contaminated soil and to improve soil quality (PH control, increase microorganisms, improve moisture retention rate, etc.), to remove air and water pollution, to improve concrete strength and to store carbon, to perform electromagnetic wave shielding, and to contribute to improvement of heat transfer.

Furthermore, the technology regarding the hydrogen production system using the biochar oven according to the present disclosure may be used to produce the hydrogen by separating the carbon from the waste plastic and the fossil fuels such as coal, oil, LPG, and liquefied natural gas in the absorbed manner thereof into the biochar.

### BRIEF DESCRIPTION OF DRAWINGS

FIG. 1 is a schematic diagram for illustrating a hydrogen production system using a biochar oven according to an embodiment of the present disclosure.

FIG. 2 is a schematic diagram for illustrating a hydrogen production system using a biochar oven according to another embodiment of the present disclosure.

FIG. 3 is an example diagram in which a vertical pyrolysis furnace in FIG. 1 is installed so as to vertically extend through a plate-shaped flameless heater.

FIG. 4 is an example diagram in which a vertical pyrolysis furnace in FIG. 2 is installed so as to vertically extend through a plate-shaped flameless heater.

FIG. 5 is a table showing experimental data under various conditions using the hydrogen production system according to the present disclosure.

FIG. 6 is a graph of contents of components of BOG when only biomass raw material is pyrolyzed as an experimental result of the present disclosure.

FIG. 7 is a graph of a BOG composition based on a height of a layer of biochar made of wood pellets as an experimental result of the present disclosure.

FIG. 8 is a graph of a BOG composition based on a height of a layer of biochar made of coffee grounds as an experimental result of the present disclosure.

FIG. 9 is a graph of contents of components of BOG when a mixed raw material of waste plastic and biomass is pyrolyzed as a result of the experiment of the present disclosure.

FIG. 10 is a graph of a BOG composition of wood pellets based on change in a pyrolysis furnace temperature as an experimental result of the present disclosure.

FIG. 11 is a graph of a BOG composition based on a height of a layer of biochar made of a mixture of coffee grounds and waste plastic as an experimental result of the present disclosure.

FIG. 12 is an electron microscope image of biochar based on a type of a raw material in accordance with the present disclosure.

### BEST MODE

Specific structural and functional descriptions of embodiments according to the concept of the present disclosure disclosed herein are merely illustrative for the purpose of explaining the embodiments according to the concept of the present disclosure. Furthermore, the embodiments according to the concept of the present disclosure can be implemented in various forms and the present disclosure is not limited to the embodiments described herein.

The present invention will now be described more fully with reference to the accompanying drawings, in which exemplary embodiments of the invention are shown. This invention may, however, be embodied in many different forms and should not be construed as limited to the exemplary embodiments set forth herein. Like reference numerals in the drawings denote like elements.

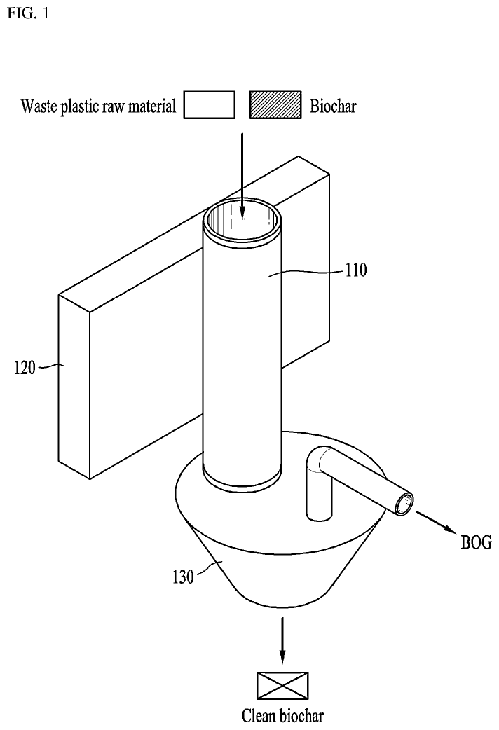

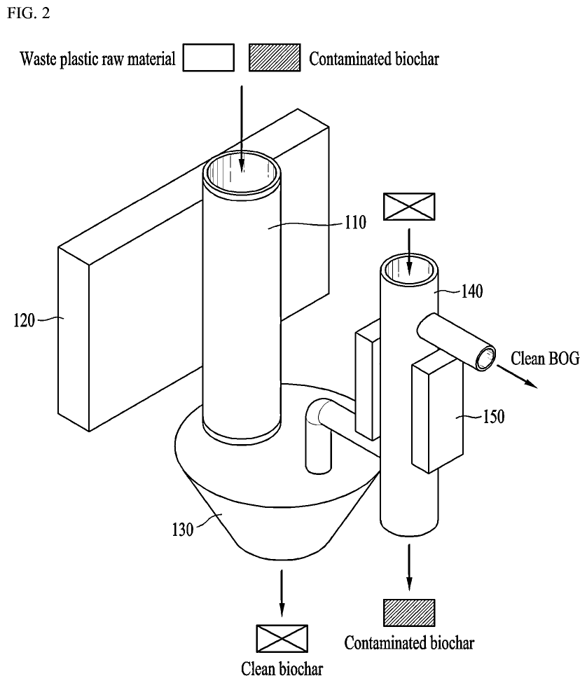

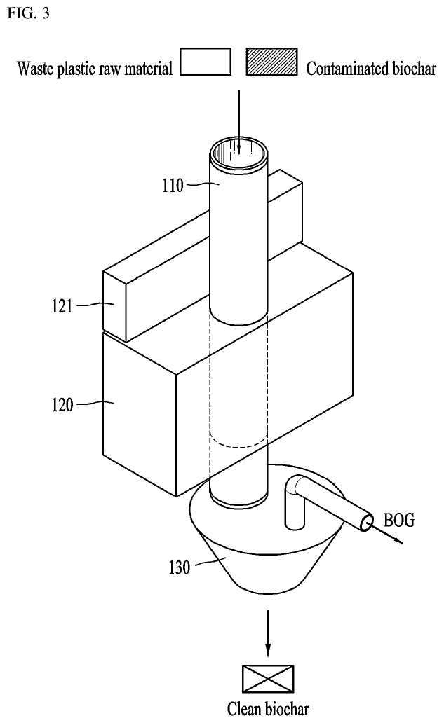

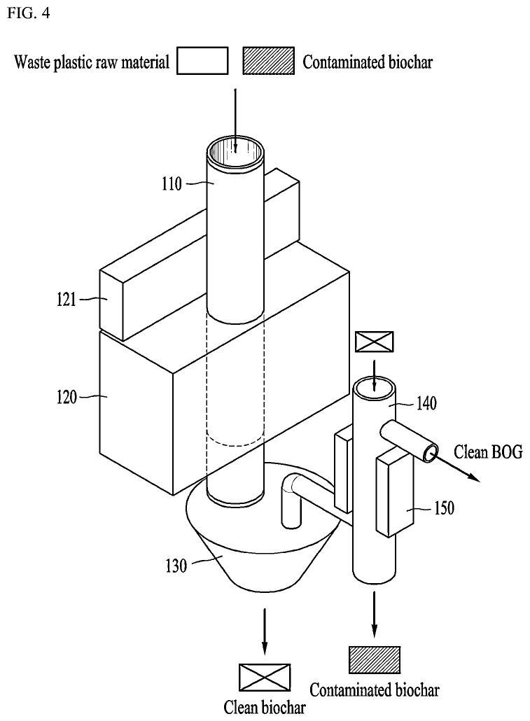

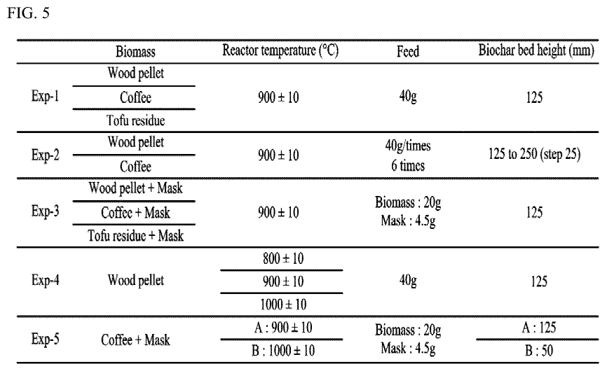

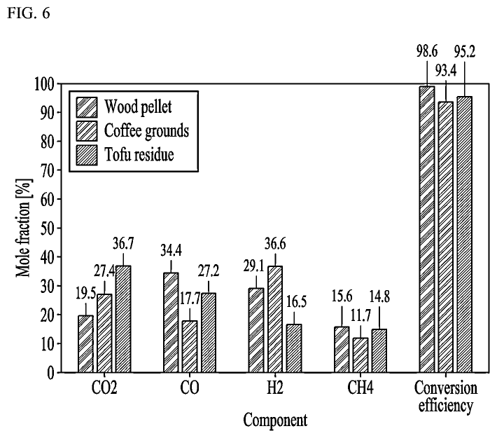

FIG. 1 is a schematic diagram for illustrating a hydrogen production system using a biochar oven according to an embodiment of the present disclosure. FIG. 2 is a schematic diagram for illustrating a hydrogen production system using a biochar oven according to another embodiment of the present disclosure. FIG. 3 is an example diagram in which a vertical pyrolysis furnace in FIG. 1 is installed so as to vertically extend through a plate-shaped flameless heater. FIG. 4 is an example diagram in which a vertical pyrolysis furnace in FIG. 2 is installed so as to vertically extend through a plate-shaped flameless heater. FIG. 5 is a table showing experimental data under various conditions using the hydrogen production system according to the present disclosure. FIG. 6 is a graph of contents of components of BOG when only biomass raw material is pyrolyzed as an experimental result of the present disclosure.

Referring to FIG. 1, the hydrogen production system according to the present disclosure is largely composed of a vertical pyrolysis furnace 110, a plate-shaped flameless heater 120, and a solid-gas separator 130.

First, the vertical pyrolysis furnace 110 provides an oven structure in which pyrolysis treatment of a pyrolysis target is performed in a high temperature atmosphere of 700° C. to 1100° C. The vertical pyrolysis furnace 110 may be embodied as a cylindrical or square tubular heating furnace extending in a vertical direction. In this regard, an inlet through which the pyrolysis target is introduced into the vertical pyrolysis furnace 110 is formed at an upper end of the vertical tubular furnace, and an outlet through which a heat-treated biochar-gas mixture is discharged out of the vertical pyrolysis furnace 110 is formed at a lower end of the vertical tubular furnace.

In this regard, a door that may be opened and closed may be installed at each of the inlet and the outlet. While the pyrolysis target is pyrolyzed in a high-temperature atmosphere, both doors may be sealed to maintain a vacuum inside the furnace 110.

The plate-shaped flameless heater 120 is installed outside the vertical pyrolysis furnace 110 to heat the vertical pyrolysis furnace 110 so that a high-temperature atmosphere in a range of 700° C. to 1100° C. is generated. The plate-shaped flameless heater 120 may be spaced apart from the vertical pyrolysis furnace 110 by a predetermined distance and may transfer heat to the vertical pyrolysis furnace 110 in a radiation and convection manner.

The plate-shaped flameless heater 120 in accordance with the present disclosure provides a biochar oven operating in a flameless combustion scheme as a pyrolysis heat source.

The flameless combustion scheme maintains the internal temperature of the vertical pyrolysis furnace 110 at a uniformly high temperature in the range of 700 to 1100° C. during biomass pyrolysis, and thus pyrolyzes the pyrolysis target in an oxygen-free atmosphere to produce BOG (Biochar Oven Gas) with a high heating value as a product gas while carbon is produced separately in a form of biochar.

Furthermore, maintaining the internal temperature of the vertical pyrolysis furnace 110 uniformly in the range of 700 to 1100° C. may allow the clogging problem caused by tar that occurs at low temperatures and the slag problem that occurs at high temperatures to be removed, thereby achieving a stable operation.

The solid-gas separator 130 is installed at a bottom of the vertical pyrolysis furnace 110, and is configured to receive a biochar-gas mixture produced from the vertical pyrolysis furnace 110 and to separate the mixture into the biochar and the BOG which in turn are discharged separately.

In this regard, the BOG produced from the vertical pyrolysis furnace 110 may be separated from the biochar by the solid-gas separator 130 and then may be supplied, as a fuel, to the plate-shaped flameless heater 120.

Hereinafter, a hydrogen production process using the biochar oven in accordance with the present disclosure as described above is described.

Referring to FIG. 1, first, the pyrolysis target is mixed with biomass or biochar to produce a mixture and then, the mixture is introduced downwardly into the vertical pyrolysis furnace 110. The biochar introduced at this time may be the previously produced biochar which may be reintroduced together with the pyrolysis target.

In this regard, a mixing ratio of the pyrolysis target and the biomass or biochar may be in a range of 1 to 90% by volume.

Furthermore, the inputting may be performed using screw feeders, loop feeders, or gear-type feeders. However, the present disclosure is not limited thereto. When a shape of the pyrolysis furnace is a cylindrical shape, a size of the inputted material is preferably within 20% of a diameter of the cylindrical shape. When a shape of the pyrolysis furnace is a plate shape, the size of the inputted material is preferably within 20% of a minimum width of the plate-shape.

Fossil fuel is injected from a position on top of the vertical pyrolysis furnace 110 into the vertical pyrolysis furnace 110. The fossil fuel gradually descends in a free fall scheme under gravity. As the fossil fuel descends, it undergoes a pyrolysis process in a high-temperature atmosphere.

In this regard, the pyrolysis target may be either waste plastic or a mixture of waste plastic and biomass.

In particular, the pyrolysis target may include a waste mask made of PP and PE as a filter material. The biomass may include one of wood pellets, wood chips, livestock manure pellets, coffee grounds, or tofu residues, or a mixture thereof.

Alternatively, the pyrolysis target may be a mixture of any one of fossil fuels including LPG, petroleum, coal, and liquefied natural gas.

In this regard, as the plate-shaped flameless heater 120 generates the heat at a uniform high temperature in the range of 800 to 1300° C., the inside of the vertical pyrolysis furnace 110 installed adjacent to the plate-shaped flameless heater 120 is heated to a range of 700 to 1100° C. and is maintained at this temperature range.

In a biochar oven area, pyrolysis of the biomass and the pyrolysis target occurs in an oxygen-free condition at a high temperature of over 800° C. The BOG as the gas produced from the pyrolysis generally contains a high concentration of tar. However, as this gas passes through a high-temperature biochar layer, the gas undergoes a cracking reaction in which the hydrocarbon is broken, such that carbon is absorbed into the biochar so as to be converted into nanocarbon fibers, while BOG containing a high concentration of hydrogen is produced.

The temperature at this time is a safe temperature range where the pyrolysis target is completely pyrolyzed, furthermore, the tar of the raw material is completely pyrolyzed, and the mineral (metal oxide) components are not melted. The movement of the fossil fuel within the pyrolysis furnace may be achieved smoothly only by gravity.

The biochar-gas mixture containing biochar and BOG that has passed through a heating area of the vertical pyrolysis furnace 110 is moved downwardly into the solid-gas separator 130 installed at the bottom of the vertical pyrolysis furnace 110. The separator 130 may separate the mixture into the biochar in a form of a solid and the BOG as the product gas. The solid biochar is discharged to a position under the solid-gas separator 130 by gravity, while the gaseous BOG is separated therefrom and discharged through an exhaust pipe installed at a top of the solid-gas separator 130.

In this regard, the BOG separated from the solid-gas separator 130 may be supplied, as the fuel, to the plate-shaped flameless heater 120.

The hydrogen production system of the present disclosure may separate 30 to 50% of the carbons contained in the pyrolysis target therefrom, and may store the separated carbons into storage. Thus, blue hydrogen may be produced using the pyrolysis target. A concentration of hydrogen contained in the produced BOG is around 50% and a concentration of CO contained therein is around 40%, such that the produced BOG may be used as an alternative fuel to natural gas. Furthermore, the produced BOG may be used as a gas raw material for various chemical processes.

Furthermore, according to the present disclosure, the produced biochar may be used to restore contaminated soil and to improve soil quality (PH control, increase microorganisms, improve moisture retention rate, etc.), to remove air and water pollution, to improve concrete strength and to store carbon, to perform electromagnetic wave shielding, and to contribute to improvement of heat transfer.

FIG. 3 is an example diagram in which the vertical pyrolysis furnace in FIG. 1 is installed so as to vertically extend through the plate-shaped flameless heater. As shown in FIG. 3, the vertical pyrolysis furnace 110 may be installed to extend through the plate-shaped flameless heater 120 in the vertical direction such that the heater may heat the furnace.

In this regard, when the vertical pyrolysis furnace 110 extends through the plate-shaped flameless heater 120, a heating area is the same as that in FIG. 1, while as the combustion gas amount and heat transfer rate increase compared to those in FIG. 1, a high temperature atmosphere may be generated, such that the pyrolysis performance of the biomass and the pyrolysis target may be improved.

In this regard, a flameless burner 110 may be installed on a top surface of the plate-shaped flameless heater 120 and may be located on one side of the vertical pyrolysis furnace 110.

The technology regarding the hydrogen production system using the biochar oven according to the present disclosure may be used to produce the hydrogen by separating the carbon from the waste plastic and the fossil fuels such as coal, oil, LPG, and liquefied natural gas in the absorbed manner thereof into the biochar.

FIG. 2 is a schematic diagram for illustrating a hydrogen production system using a biochar oven according to another embodiment of the present disclosure. Referring to FIG. 2, the hydrogen production system according to another embodiment of the present disclosure may be largely composed of the vertical pyrolysis furnace 110, the plate-shaped flameless heater 120, the solid-gas separator 130, and a BOG purification unit 140.

The vertical pyrolysis furnace 110 receives the fossil fuel falling down by its own weight. The plate-shaped flameless heater 120 heats the vertical pyrolysis furnace 110 to generate a high temperature atmosphere of 800 to 1300° C. therein. The solid-gas separator 130 is installed at the bottom of the vertical pyrolysis furnace 110 and receives the biochar-gas mixture generated from the vertical pyrolysis furnace 110, and separates the mixture into the biochar and the BOG, and discharges the biochar and the BOG in a separate manner.

The produced gas BOG separated by the solid-gas separator 130 may be subjected to a purification process to remove impurities through a BOG purification unit 140.

In this regard, the BOG purification unit 140 may receive the biochar produced in a previous process and use the same as an adsorbent. The separated BOG may pass through the biochar received in the BOG purification unit 140 such that impurities in the BOG are removed therefrom.

For example, for optimal by-product production and hydrogen production, it may be preferable to increase a treatment percentage of the pyrolysis target. However, when the pyrolysis target is treated at an excessively high percentage, a large amount of difficult-to-handle pollutants, such as the tar generated from the pyrolysis target are produced, and, thus, a phenomenon occurs in which they attach to a passage and block the passage in a subsequent process. Furthermore, impurities to improve a function of the pyrolysis target, such as chlorine contained in PVC are contained therein. The impurities are converted into pollutants during the combustion such that the pollutants are contained into the BOG. Therefore, a process for treating the impurities contained in the BOG is necessary.

To this end, the technology for purifying the BOG using the adsorption performance of the self-produced biochar in another embodiment of the present disclosure as shown in FIG. 2 is described below.

As shown in FIG. 2, clean biochar separated using the solid-gas separator 130 is put into the BOG purification unit 140 and is used as a filter (adsorbent) therein.

In this regard, a temperature control device 150 is installed in the BOG purification unit 140 to control a temperature when purifying the BOG gas.

The temperature control device 150 as described above may create a temperature distribution that maximizes the adsorption efficiency of various pollutants via temperature control, thereby enabling continuous BOG purification.

In this regard, the biochar used in the BOG purification unit 140 is composed of carbon at a content of 5% or greater, and has a high adsorption performance comparable to that of the activated carbon, and thus can adsorb and remove heavy metals and various high molecular hydrocarbons from the BOG such that the BOG has a high quality similar to that of the natural gas.

Moreover, the contaminated biochar after being used for the BOG purification is not discharged as waste, but may be reintroduced into the vertical pyrolysis furnace 110 and may be purified via a high-temperature pyrolysis process. This minimizes waste generation.

The temperature control device 150 may be embodied as an electrical or mechanical control system. For example, in an electrical control scheme, the temperature m may be controlled using thermoelectric elements or electric heaters. In the mechanical control scheme, a double pipe is installed and a working fluid such as air or water whose a flow rate and a temperature can be controlled flows through the pipe to control the temperature.

FIG. 4 is an example diagram in which the vertical pyrolysis furnace in FIG. 2 is installed so as to vertically extend through the plate-shaped flameless heater. As shown in FIG. 4, the vertical pyrolysis furnace 110 may be installed to extend through the plate-shaped flameless heater 120 in the vertical direction and the heater may heat the furnace.

In this regard, when the vertical pyrolysis furnace 110 extends through the plate-shaped flameless heater 120, a heating area is the same as that in FIG. 1, while as the combustion gas amount and heat transfer rate increase compared to those in FIG. 1, a high temperature atmosphere may be generated, such that the pyrolysis performance of the biomass and the pyrolysis target may be improved.

In this regard, the flameless burner 110 may be installed on a top surface of the plate-shaped flameless heater 120 and may be located on one side of the vertical pyrolysis furnace 110.

Referring to FIG. 5 to FIG. 12, the experimental result under each of conditions as conducted using the hydrogen production system according to the present disclosure is described.

Basic operating characteristics of the flameless combustion-based biochar oven were identified based on experimental results conducted under various conditions of the hydrogen production system according to the present disclosure. The mixture fuels of three types of biomass: wood pellets, coffee grounds, and tofu residue, and the pyrolysis target (for example, disposable mask waste) were treated in a batch manner and a semi-continuous manner.

Furthermore, based on the experimental results, the nature and the state of the BOG based on the pyrolysis furnace temperature and the type of the fuel were identified, and nanocarbon fibers formed on the biochar surface were identified. Thus, cracking on the high-temperature biochar surface was identified, and performance based on a reactor temperature and the nature and the state of the fuel was identified.

FIG. 5 is a table showing experimental data under various conditions using the hydrogen production system according to the present disclosure.

Referring to FIG. 5, Experiment 1 (Exp-1) is an experiment to analyze the composition of BOG gas obtained by injecting 40 g of each of three types of biomasses at once to the furnace. Experiment 2 (Exp-2) is an experiment of evaluating the nature and the state of the BOG based on the height of biochar as obtained by repeatedly adding raw materials such that the height of the underlying biochar layer reaches 25 mm. Experiment 3 (Exp-3) is an experiment of evaluating the nature and the state of the BOG and change in the biochar surface when the pyrolysis target together with biomass are added to the furnace. Experiment 4 (Exp-4) evaluates the effect of temperature while increasing the biochar temperature using wood pellets with a relatively high melting point of ash thereof.

Coffee grounds and tofu residue were excluded from the experiment because the ash components thereof melted at 1000° C. and thus, clogging occurred due to slag. In all experiments, raw materials were added thereto 10 minutes after adding the basic biochar thereto. The BOG gas concentration was analyzed as the average value of those obtained for the period for which the oxygen concentration in the BOG was 0.

FIG. 6 is a graph of contents of components of BOG when only biomass raw material is pyrolyzed as an experimental result of the present disclosure.

Referring to FIG. 6, the wood pellet has the lowest moisture content and the highest hydrogen content, and thus, a temperature reduction effect thereof due to moisture is insignificant, and active hydrogen promotes tar decomposition, such that the highest decomposition efficiency thereof is achieved.

In this regard, the reason why the coffee ground has the highest hydrogen content and lowest methane content is because the oxygen concentration of the coffee ground among the raw materials is the lowest, while the content of the moisture thereof that promotes hydrogen production via a methane-steam reforming reaction is the highest.

Further, the reason why the tar decomposition efficiency of the coffee grounds is the lowest is because the high moisture content thereof has the effect of lowering the temperature inside the pyrolysis furnace during the reaction.

The tofu residue which has a high oxygen concentration is found to have the lowest hydrogen concentration and the highest content of a combination of CO and CO₂. This is because the oxygen component of the tofu residue as the fuel promotes the combustion of carbon and hydrogen.

Furthermore, the concentration of methane was relatively high. That is, the concentration of methane in the coffee grounds is 11.7%. The concentration of methane in wood pellets is 15.6%. This is due to the fact that a product gas residence time is short due to the rapid reaction of the raw material introduced at once via the pyrolysis, so that a sufficient methane destruction reaction does not occur.

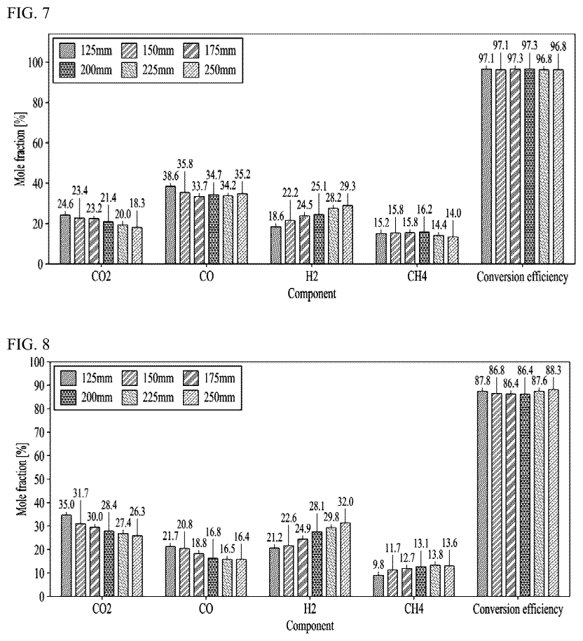

FIG. 7 is a graph of a BOG composition based on a height of a layer of biochar made of wood pellets as an experimental result of the present disclosure. FIG. 8 is a graph of a BOG composition based on a height of a layer of biochar made of coffee grounds as an experimental result of the present disclosure.

Referring to FIG. 7 and FIG. 8, it may be identified that a H₂ content in the BOG increases by up to a value of 10.7 to 10.8% as the height of the biochar layer increases in each of the wood pellets in FIG. 7 and the coffee grounds in FIG. 8. As the height of the biochar layer increases, the CO₂ and CO contents of wood pellets decrease by 6.3% and 3.4%, respectively, and the CO₂ and CO contents of coffee grounds decrease by up to 8.7% and 5.3%, respectively.

In this regard, the coffee grounds have the high moisture content and the high content of inorganic substances beneficial for carbon adsorption. Thus, the CO₂ and CO content reduction effect of the coffee grounds is found to be greater than that of wood pellets.

For example, as the height of the biochar layer in the biochar oven increases, the cracking reaction time of the pyrolysis gas on the biochar surface increases, such that a larger amount of hydrocarbon (HC) is decomposed, and the carbon is adsorbed on the biochar surface, thereby increasing the hydrogen concentration, and decreasing the CO and CO₂ concentration.

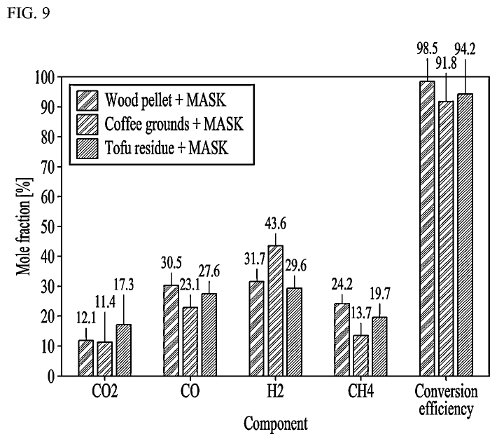

FIG. 9 is a graph of contents of components of BOG when a mixed raw material of waste plastic and biomass is pyrolyzed as a result of the experiment of the present disclosure.

Referring to FIG. 9, when the raw material as a mixture of the biomass with the pyrolysis target (mask) is pyrolyzed, the CO₂ content in the BOG is reduced by 14.3% and the contents of CO, H₂, and CH₄ increase by 0.8%, 7.5%, and 5.2%, respectively, on average, compared to those when only the biomass is pyrolyzed as in Experiment 1 (Exp-1).

This is because hydrocarbons as the main component of the mask which is the pyrolysis target are subjected to the pyrolysis and pass through the high-temperature biochar such that the hydrocarbons are cracked into CO and H₂ via a catalytic reaction.

Furthermore, despite adding the pyrolysis target thereto, the conversion efficiency only decreases by 1 to 2%. This is because considering the high heating value of the pyrolysis target, the input amount of biomass is reduced by half, such that the heating value of the input raw materials is kept constant, such that a flow rate of pyrolysis gas is adjusted to maintain the cracking performance of biochar.

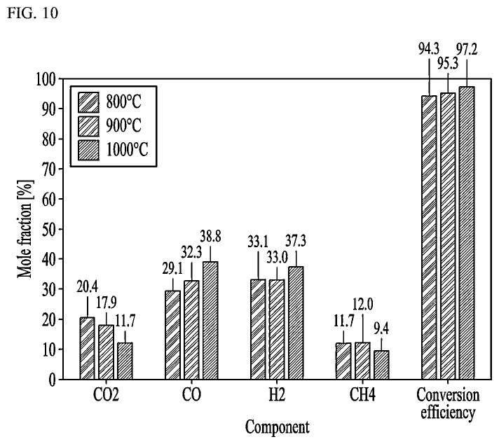

FIG. 10 is a graph of a BOG composition of wood pellets based on change in a pyrolysis furnace temperature as an experimental result of the present disclosure.

Referring to FIG. 10, it may be identified that as the temperature increases, the contents of the components of BOG change as follows: the CO content increases by 9% to 38.8% and the H₂ content increases by 4% to 37.3%. Additionally, the conversion efficiency increases by 3% to reach 97.2%.

In this process, the content of CH₄ as the smallest hydrocarbon (HC) decreases by 2.3%. The increase in the contents of H₂ and O and the decrease in the content of CO₂ as the reaction furnace temperature increases are due to a dry reforming reaction (CH₄+CO₂→2CO+2H₂).

Based on the above result, it may be identified that as the temperature of the reaction furnace increases, the hydrocarbon (HC) cracking and the reforming reaction of the biochar in the biochar oven occur smoothly.

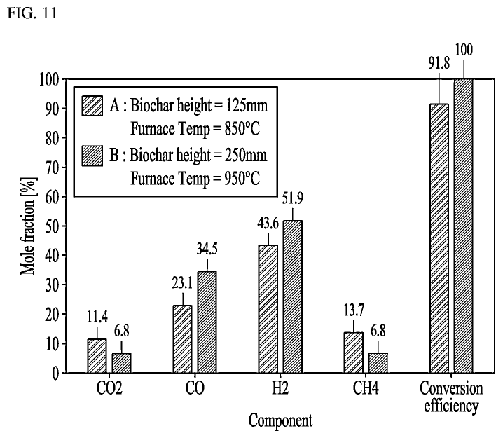

FIG. 11 is a graph of a BOG composition based on a height of a layer of biochar made of a mixture of coffee grounds and waste plastic as an experimental result of the present disclosure.

Referring to FIG. 11, a graph shows the composition of BOG gas when being tested under pyrolysis furnace temperatures of 850° C. and 950° C. and at a mixing ratio of 25% pyrolysis target (mask) and 75% biomass (wood pellets).

In this regard, the conversion rate represents the sum of the contents of the measured gas components (CO, CO₂, H₂, CH₄). At 950° C., the BOG containing 52% hydrogen, 34.5% CO, and 6.8% methane produces high-quality gas fuel containing hydrogen that is not achieved in existing bio pyrolysis/gasification plants. The conversion rate reaches 100%, thus indicating that all of tar and other high molecular weight hydrocarbons are decomposed into small molecules.

The contents of CO and H₂ as the final cracking products of hydrocarbon (HC) increase by 11.4% and 8.3%, respectively, as the temperature and the height of the biochar layer increase. The content of CH₄ as the smallest hydrocarbon (HC) decreases by 6.9% in a condition B compared to that in a condition A. Under the condition B, the conversion efficiency is 100%, thus indicating that all hydrocarbons except CH₄ are cracked.

Therefore, it may be identified that when the mixture of the plastic raw material with the biomass raw material is used and as the temperature and the height of the biochar layer increase, the high H₂ content in BOG and the high conversion efficiency may be achieved.

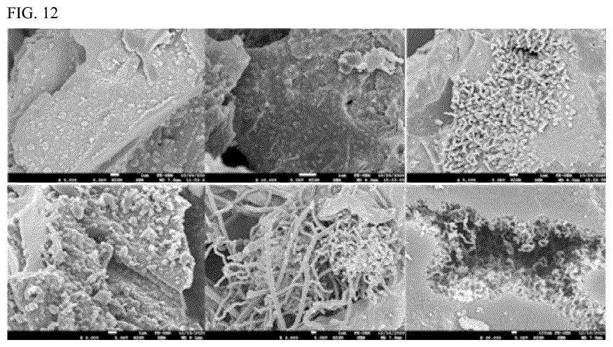

FIG. 12 is an electron microscope image of biochar based on a type of a raw material in accordance with the present disclosure. FIG. 12 shows an electron micrograph of biochar produced depending on whether or not various biomasses and the pyrolysis target (mask) are mixed with each other. (a), (b), and (c) in FIG. 12 show the biochar produced only from wood pellets, coffee grounds, and tofu residue, respectively as the biomass raw material. (d), (e), and (f) in FIG. 12 show the biochar produced from the mixtures obtained by mixing wood pellets, coffee grounds, and tofu residue, respectively as the biomass with the pyrolysis target (mask).

Referring to FIG. 12, it may be identified that when the mixture of the pyrolysis target and the biomass is used, many carbon fibers are attached to the biochar surface, thereby increasing the biochar surface area. Thus, a specific surface area (BET) measurement result thereof reaches 250 to 300 m2/g, indicating that the biochar may be used as an industrial product to replace expensive activated carbon.

Referring to (d) in FIG. 12, it may be identified that the biochar obtained using the mixture of the wood pellets and waste plastic (mask) has hexagonal carbon grown on the surface thereof compared to the biochar produced only from the biomass.

Referring to (e) and (f) in FIG. 12, it may be identified that in each of the biochar obtained using the mixture of the coffee grounds and the pyrolysis target (mask), and the biochar obtained using the mixture of the tofu residue and the pyrolysis target (mask), the carbon fiber has grown significantly compared to that in the biochar produced only from the biomass.

In particular, it may be identified that the pyrolysis target (mask), and the biochar obtained using the mixture of the tofu residue and the pyrolysis target (mask), small carbon wires are developed inside the pores.

In this regard, the surface area which plays a large role in the adsorption of the biochar increases as the porosity increases and as the number of carbon wires and the number of the hexagonal carbons on the surface increase. Therefore, the biochar produced from the mixture of the biomass with the mask as the pyrolysis target is more effective in adsorbing the pollutants and storing the moisture therein. The biochar produced using the combination of each of the coffee grounds the tofu residue with the mask may be used not only as an adsorbent and soil improver, but also as a carbon material such as nanotubes and graphene.

The system and the method of the present disclosure are to produce the biochar and the BOG by conducting indirect pyrolysis of the raw materials in the pyrolysis furnace at a uniform temperature as heated in the flameless combustion manner and passing the pyrolysis gas through the high-temperature biochar catalyst layer. The plate-shaped flameless heater operating in the flameless combustion scheme as used in the method and the system of the present disclosure may include a plate-shaped housing having a combustion space defined therein; an oxidizing agent injecting unit provided on one side of the housing so as to inject and circulate the oxidizing agent along the outer circumference in the inner combustion space through the oxidizing agent injecting nozzle to form a first circulation area; a gas discharge unit provided on the other side of the housing so as to discharge a portion of the gas circulating in the combustion space; a fuel supply unit having a tip of a fuel injection nozzle located within a second circulation area formed in a center of the combustion space due to the circulation of the oxidizing agent in the first circulation area so as to inject the fuel into the second circulation area; and a combustion heat dissipating plate that generates spatial combustion within the combustion space around the second circulation area as the fuel injected into the second circulation area is gradually mixed with the oxidizing agent circulating along the first circulation area.

Furthermore, the above plate-shaped flameless heater may be embodied as an electric scheme heater.

Summarizing the experimental results of the present disclosure as identified above, in Experiment 1 (Exp-1), the moisture content in the wood pellets as the raw material was low, and the hydrogen content therein was high. Thus, the highest conversion efficiency was achieved. The coffee grounds as the raw material had high moisture content, so that the H₂ content in BOG was high and the CH₄ content in BOG was the lowest. The tofu residue as the raw material had the high oxygen content such that the tofu residue BOG had relatively high CO and CO₂ contents.

Further, in Experiment 2 (Exp-2), each of the coffee grounds and the wood pellets was used as the raw material to increase the height of the biochar layer. As a result, the CO and CO₂ contents in BOG based on each of the both raw materials tended to decrease, and the H₂ content therein tended to increase.

Moreover, in Experiment 3 (Exp-3), based on the mixture of the biomass and the mask (pyrolysis target), the CO₂ content in BOG decreased while the CO, H₂, and CH₄ contents therein increased, compared to those in Exp-1.

In general, the waste plastic (pyrolysis target) is composed of hydrocarbons in the form of polymers. Thus, the CO₂ content is reduced, and the carbon wire sticks to the biochar, increasing the reaction surface area, and thus activating the conversion reaction.

Moreover, in Experiment 4 (Exp-4), as a result of increasing the temperature of the biochar oven, the CO₂ and CH₄ contents decreased while the CO and H₂ contents and the conversion efficiency increased. The higher the reaction temperature, the better the conversion efficiency.

Moreover, in Experiment 5 (Exp-5), when the temperature of the biochar oven and the height of the biochar layer were increased, the CO₂ and CH₄ contents decreased while the CO and H₂ contents increased, and the decomposition efficiency 100% was achieved.

For example, it was identified that when the temperature of the biochar oven and the height of the biochar layer were increased, the H₂ content in BOG and the conversion efficiency increased, and thus the cracking occurred well.

Thus, BOG with the H₂ content of up to 50% can be produced using the mixture of the pyrolysis target as the waste and the biomass as the raw material. In addition, it was identified based on the SEM analysis result of the produced biochar that the biochar had the special surface on which the carbon nanowires were grown when the combination of the plastic and the biomass was used.

According to the present disclosure, greenhouse gases and pollutants as produced during the incineration and landfill treatment of the biomass and the pyrolysis target may be reduced. The high-quality biochar as produced may not only be used as advanced industrial materials such as adsorbents and catalysts, but may also produce the BOG with the high hydrogen content which may be used as the fuel, and the remaining BOG may be reformed to produce the hydrogen fuel.

Although the present invention has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

1. A hydrogen production system using a biochar oven, the system comprising:
a vertical pyrolysis furnace configured to perform pyrolysis treatment of a pyrolysis target including at least one of waste plastic and fossil fuel under a high temperature atmosphere of 700° C. to 1100° C.; and
a plate-shaped flameless heater configured to heat the vertical pyrolysis furnace, and to use biochar oven gas (BOG) produced from the vertical pyrolysis furnace as fuel to heat the vertical pyrolysis furnace.

2. A hydrogen production system using a biochar oven, the system comprising:
a vertical pyrolysis furnace into which a pyrolysis target including at least one of waste plastic and fossil fuel is supplied in a free fall scheme by its own weight;
a plate-shaped flameless heater configured to heat the vertical pyrolysis furnace such that a high-temperature atmosphere of 800 to 1300° C. is generated therein;
a solid-gas separator installed under a bottom of the vertical pyrolysis furnace and configured to receive a biochar-gas mixture produced from the vertical pyrolysis furnace and to separate the biochar-gas mixture into the BOG and the biochar and to discharge the BOG and the biochar; and
a BOG purification unit configured to receive therein the biochar separated using the solid-gas separator therefrom, and use the received biochar as an adsorbent, wherein the BOG separated using the solid-gas separator passes through the received biochar in the BOG purification unit such that impurities contained in the BOG are removed therefrom.

3. The hydrogen production system of claim 1, wherein the vertical pyrolysis furnace vertically extends through the plate-shaped flameless heater and is heated by the heater.

4. The hydrogen production system of claim 3, wherein a flameless burner is installed on a top of the plate-shaped flameless heater and is located on one side of the vertical pyrolysis furnace.

5. The hydrogen production system of claim 2, wherein the BOG purified using the BOG purification unit is used as fuel of the plate-shaped flameless heater.

6. The hydrogen production system of claim 2, wherein contaminated biochar used for the BOG purification in the BOG purification unit is reintroduced into the vertical pyrolysis furnace and is subjected to a pyrolysis process therein.

7. The hydrogen production system of claim 2, wherein a temperature control device is installed at the BOG purification unit and is configured to control a temperature of the BOG purification unit in an electrical or mechanical scheme.

8. The hydrogen production system of claim 2, wherein the pyrolysis target is one of waste plastic, a mixture of waste plastic and biomass, a waste mask including PP and PE as a filter material, or a fossil fuel including LPG, petroleum, coal, and liquefied natural gas.

9. The hydrogen production system of claim 8, wherein the biomass includes one of wood pellets, wood chips, livestock manure pellets, coffee grounds, or tofu residues, or a mixture thereof.

10. A hydrogen production method using a biochar oven, the method comprising:
inputting a pyrolysis target into a vertical pyrolysis furnace in a free fall manner under a gravity;
generating heat in a range of 800 to 1300° C. from a plate-shaped flameless heater installed on one side of the vertical pyrolysis furnace to maintain an internal temperature of the vertical pyrolysis furnace at around 700 to 1100° C. such that a biochar-gas mixture is produced from the vertical pyrolysis furnace;
transferring a biochar-gas mixture produced from the vertical pyrolysis furnace is to a solid-gas separator in which the solid-gas separator separates the biochar-gas mixture into solid biochar and gaseous BOG, and discharges the solid biochar downwardly by gravity, and discharges the gaseous BOG upwardly to an exhaust pipe;
filling the solid biochar separated using the solid-gas separator into a BOG purification unit so as to be used as an adsorbent thereby; and
passing the BOG separated using the solid-gas separator through the biochar contained in the BOG purification unit such that the adsorbent absorbs and removes impurities contained in the BOG.

11. The hydrogen production method of claim 10, wherein the pyrolysis target is mixed with biomass or biochar and a mixture thereof is put into the pyrolysis furnace.

12. The hydrogen production method of claim 10, wherein the BOG purified using the BOG purification unit is used as fuel of the plate-shaped flameless heater.

13. The hydrogen production method of claim 10, wherein contaminated biochar used for the BOG purification in the BOG purification unit is reintroduced into the vertical pyrolysis furnace and is subjected to a pyrolysis process therein.

14. The hydrogen production method of claim 10, wherein a temperature control device is installed at the BOG purification unit and is configured to control a temperature of the BOG purification unit in an electrical or mechanical scheme.

15. The hydrogen production method of claim 10, wherein the pyrolysis target is one of waste plastic, a mixture of waste plastic and biomass, a waste mask including PP and PE as a filter material, or a fossil fuel including LPG, petroleum, coal, and liquefied natural gas.
